(19) United States
(12) Patent Application Publication
(10) Pub. No.: US 2015/0022772 A1
(43) Pub. Date: Jan. 22, 2015

(54) DISPLAY DEVICE AND METHOD FOR MANUFACTURING THE SAME

(71) Applicant: Japan Display Inc., Minato-ku (JP)

(72) Inventor: Muneharu AKIYOSHI, Minato-ku (JP)

(73) Assignee: Japan Display Inc., Minato-ku (JP)

(21) Appl. No.: 14/326,602

(22) Filed: Jul. 9, 2014

(30) Foreign Application Priority Data
Jul. 18, 2013 (JP) 2013-149685

(51) Int. Cl. G02F 1/1339

(52) U.S. Cl. CPC G02F 1/1339
USPC 349/153; 445/25

(57) ABSTRACT

According to one embodiment, a liquid crystal panel and its manufacturing method are provided that can ensure a bonding strength between substrates that a sealed portion provides, while achieving a narrowed frame. The liquid crystal panel includes a pair of corrective structures provided in a manner protruding from an array substrate toward a counter substrate. The liquid crystal panel further includes a counter structure disposed in at least a portion of the frame area and provided in a manner protruding from the counter substrate toward the array substrate, the leading end of the structure coming closer to the surface of the array substrate than the leading ends of the corrective structures and positioned between the corrective structures. A sealed portion arranged to bond the substrates to each other is formed through curing of a fluidic sealing material and provided between the corrective structures and the counter structure.

### INCORPORATION BY REFERENCE

The present invention claims priority under 35 U.S.C. §119 to Japanese Patent Application No. 2013-149685 filed on Jul. 18, 2013. The content of the application is incorporated herein by reference in their entirety.

### FIELD

Embodiments described herein relate generally to a display device having a display area for displaying images therein and a frame area surrounding the display area and method for manufacturing the same.

### BACKGROUND

In recent years, in the market for mobile terminals such as cell-phones, since there is a need for increased screen size and definition with the size of the chassis remaining the same, so-called frame narrowing designs have been adopted to reduce the distance from the outermost edge to the screen display area (active area).

Accordingly, in liquid crystal panels for use in such mobile terminals, a sealing material for bonding of substrates disposed in a mutually opposed manner is also required to be thinned in conformity with the frame area arranged in each substrate. If the frame area had a sufficient width, a thermoset sealing material, an ultraviolet (UV) curable sealing material, a sealing material bringing together features thereof, etc., whichever might be used, could be designed to have a width thickened in conformity with the frame area and thereby provide sufficient strength for bonding of the substrates, whereby the substrates would be less likely to separate even if a stress was applied to the bonded liquid crystal panel. That is, the frame area widened could provide a sufficient sealing width to ensure a substrate bonding strength. Hence, an adjustment could be made on materials (mainly the sealing material) for an increase in the bonding strength between the substrates. For example, adding to the sealing material a component having a feature of tight linkage to side chains of the substrates, such as —OH and/or —Si═O, as an agent for increasing the sticking force to the sealing material, that is, a sticking aid to the sealing material could increase the sticking strength by several percent.

It is also necessary for the sealing material itself to be reinforced (bulk reinforced) to increase the bonding strength between the substrates. The sealing material undergoes a treatment such as thermal or ultraviolet curing so that the substrates cannot be separated. However, in polymers cross-linked during curing, monomers are cross-linked one after another in the distal direction, while cross-linking hardly progresses in the side chain direction. After the curing, cross-linked polymers cling to form a bulk, but just cling and cannot maintain a sufficient bulk strength. In order to prevent the bulk itself from uncontrollably undergoing crushing, a cross-linking agent (thermal cross-linker, UV cross-linker) is added to the sealing material so that cross-linking also progresses in the side chain direction and the bulk strength increases dramatically.

Such a measure to reinforce the sealing material is limited to the case where a certain degree of sealing width is provided because of a limitation in reinforcing the sealing material itself. That is, the smaller the area for drawing of the sealing material with frame narrowing, the smaller the bonding area of the sealing material naturally becomes. Accordingly, not all of the limited number of side chains such as —OH and/or —Si═O, which are to be disposed on the surface of the substrates, are bonded to the agent. The coordination of side chains of the substrates has directionality and it is natural that the bonding could not succeed if suffering from a structural problem during bonding.

Also, the smaller the sealing width, that is, the smaller the amount of application of the sealing material, the smaller the number of polymer bonds in the bulk and thereby the relatively lower the bulk strength becomes. However, compared to the reduction in the bonding force on the surface of the substrates, since a wide variety of polymers and additives have the space to move flexibly in the bulk, it is crucial not to lower the bonding force at the interface between the substrates and the sealing material, that is, to reduce the separation at the interface for achieving panel frame narrowing.

For application in a narrow frame area, it is necessary to apply the sealing material at an application rate lower than conventionally. It is however difficult to stably apply the sealing material at such a low application rate because it is necessary, for example, to use a needle more fine-tipped than conventionally and/or to set a lower application pressure. Moreover, since the direction of application may rapidly change particularly in the vicinity of each corner of the panel, the application speed may change and the sealing material is also likely to be thinned, which makes it difficult to set the application rate.

### BRIEF DESCRIPTION OF THE DRAWINGS

FIG. 1 is a process chart schematically showing a method for manufacturing a display device according to a first embodiment, where FIG. 1(a) shows a first protrusion forming step and a gap holding member forming step, FIG. 1(b) shows a second protrusion forming step, FIG. 1(c) shows an applying step, FIG. 1(d) shows a disposing step, and FIG. 1(e) shows a curing step. FIG. 2 is a partially enlarged cross-sectional view of the display device. FIG. 3 is a plan view of the display device. FIG. 4(a) is a plan view schematically showing a mother substrate including one of the substrates of the display device, FIG. 4(b) is a partially enlarged plan view of FIG. 4(a), FIG. 4(c) is a plan view schematically showing a mother substrate including the other of the substrates of the display device, FIG. 4(d) is a partially enlarged plan view of FIG. 4(c), and FIG. 4(e) is a plan view schematically showing the positional relationship between a first protrusion and a second protrusion. FIG. 5 is an illustrative view of a process flow of the method for manufacturing the display device. FIG. 6 is a plan view showing a portion of a display device according to a second embodiment including protrusions, where FIG. 6(a) shows an example of the shape of a first protrusion, FIG. 6(b) shows an example of the shape of a second protrusion, FIG. 6(c) shows another example of the shape of the first protrusion, and FIG. 6(d) shows another example of the shape of the second protrusion.

### DETAILED DESCRIPTION

Embodiments of the display device provide a display device having a display area for displaying an image therein and a frame area surrounding the display area. The display device includes a pair of substrates disposed in a mutually opposed manner with a predetermined gap therebetween. The display device also includes a pair of first protrusions disposed in at least a portion of the frame area in a mutually spaced manner and provided in a manner protruding from one toward the other of the substrates. The display device further includes a second protrusion disposed in at least a portion of the frame area and provided in a manner protruding from the other substrate toward the one substrate, the leading end of the second protrusion coming closer to the surface of the one substrate than the leading ends of the first protrusions and positioned between the first protrusions. The display device then includes a sealed portion arranged to bond the pair of substrates to each other. The sealed portion is formed through curing of a fluidic sealing material applied between the first protrusions and provided between the first protrusions and the second protrusion.

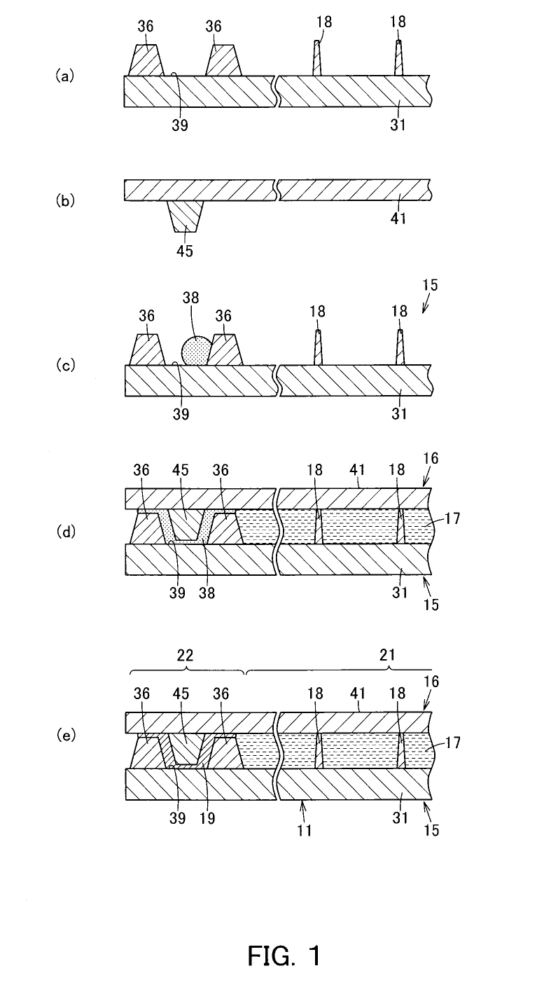

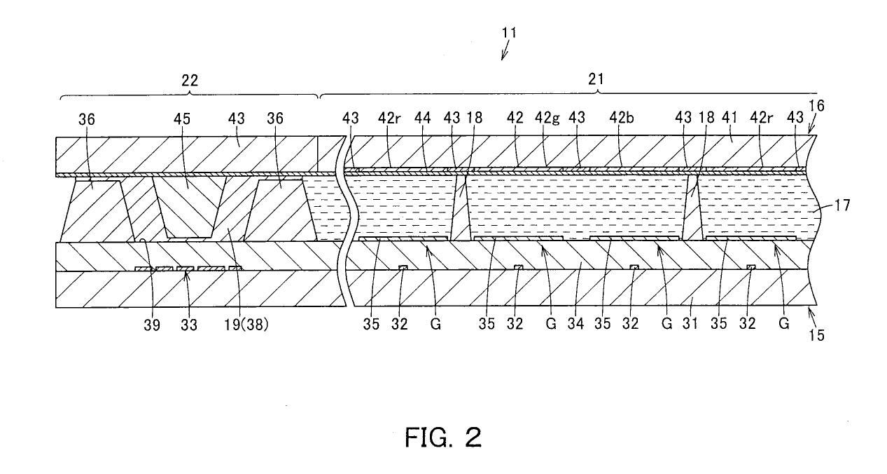

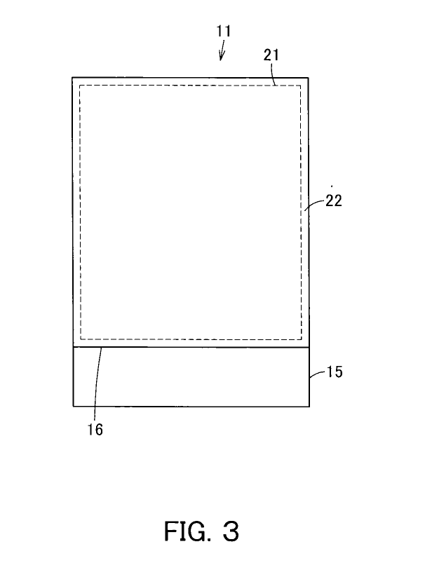

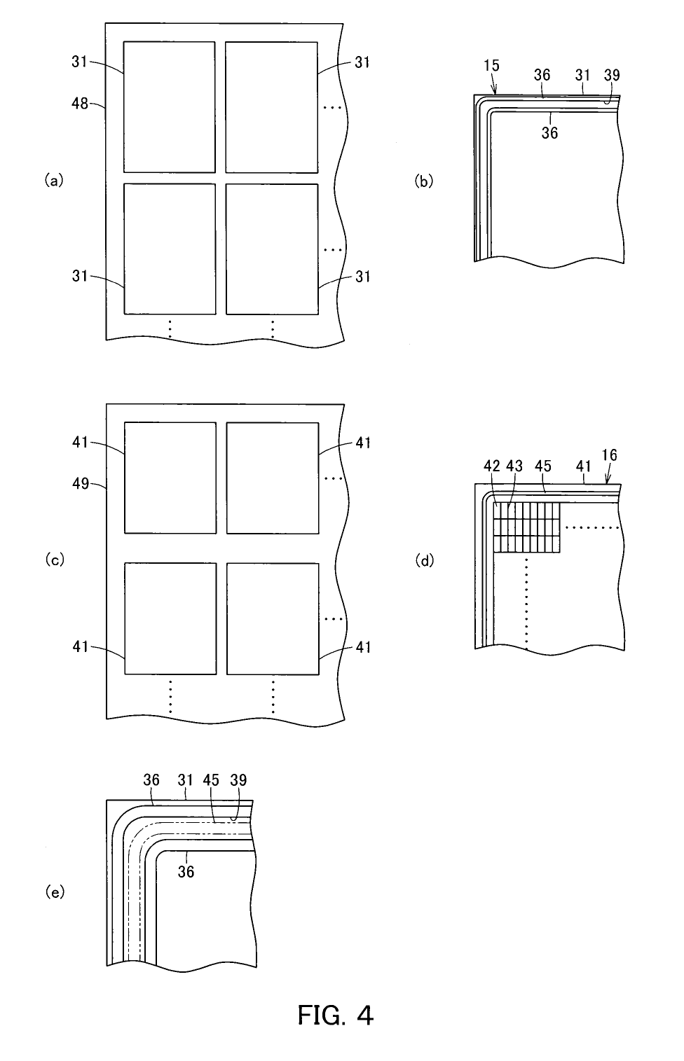

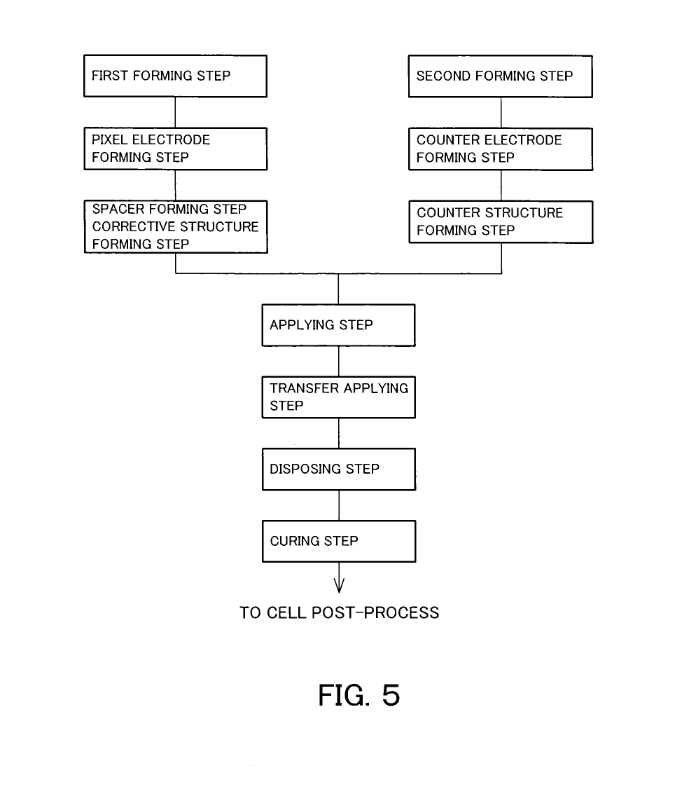

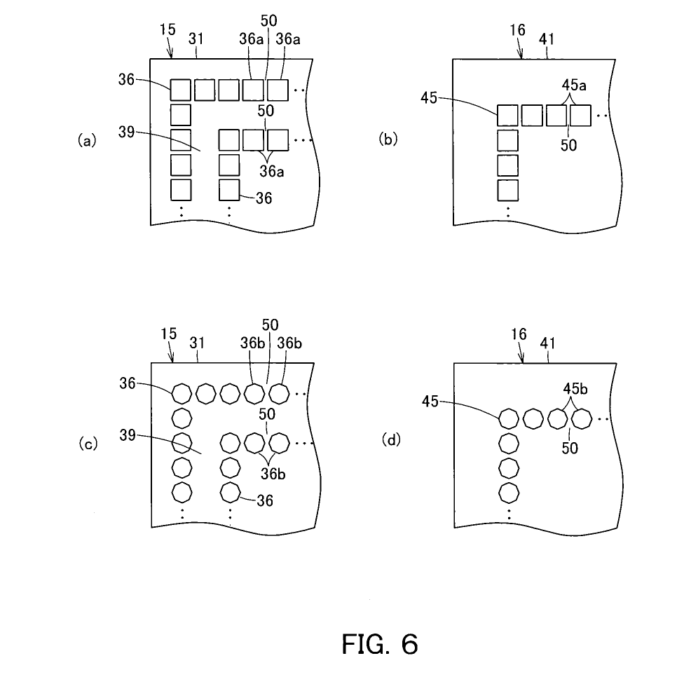

An arrangement according to a first embodiment will hereinafter be described with reference to FIGS. 1 to 5.

In FIGS. 1 to 4, the reference numeral 11 denotes a liquid crystal panel serving as a display device (liquid crystal display device). The liquid crystal panel 11, the surface of which is covered with, for example, a cover glass serving as a covering member not shown, is housed in a chassis frame not shown together with a backlight not shown to be used in, for example, a mobile terminal such as a cell-phone. In addition, the display side (upper side in FIG. 2) of the liquid crystal panel 11 is referred to as front side, while the opposite side (lower side in FIG. 2) is referred to as back side, that is, rear side in the following description.

The liquid crystal panel 11 is a transmissive active matrix type that displays an image by transmitting planar light from the backlight or a semi-transmissive active matrix type including a transmitting portion for transmitting planar light from the backlight and a reflecting portion for reflecting incident light from the front side. The liquid crystal panel 11 has an arrangement in which an array substrate 15 serving as, for example, a quadrilateral substrate and a counter substrate 16 serving as a quadrilateral substrate are disposed with the array substrate 15 on the rear side in a mutually opposed manner with a predetermined gap (cell gap) therebetween, and in which between the substrates 15 and 16, a liquid crystal layer 17 and spacers (super spacers) 18 serving as a gap holding member for holding the gap between the substrates 15 and 16 are provided, and the substrates 15 and 16 are bonded to each other with a sealed portion 19 therebetween, and in which a polarizing plate not shown is mounted on the rear side of the array substrate 15 and on the front side of the counter substrate 16. In the liquid crystal panel 11, an active area, that is, a display area 21 is formed in a quadrilateral shape in which multiple pixels (sub-pixels) G are arranged in, for example, a matrix and can display an image, and a frame area 22 in which no image is displayed is formed in a quadrilateral frame shape having at least one corner in a manner surrounding the display area 21.

The array substrate 15 includes a (first) glass substrate 31 serving as a (first) substrate body and, on a first principal surface of the glass substrate 31 closer to the liquid crystal layer 17 and in a region corresponding to the display area 21, thin film transistors (TFTs) 32 serving as switching devices for independently driving pixels G are formed together with scan lines not shown including gate electrodes, while in the frame area 22, a drive circuit 33 for driving the thin film transistors 32 are formed. An interlayer insulating film not shown is formed in a manner covering the thin film transistors 32 and the drive circuit 33, etc., and, on the interlayer insulating film, signal lines not shown are formed in the direction approximately perpendicular to that of the scan lines and connected electrically to the thin film transistors 32 via contact holes not shown formed in the interlayer insulating film. On the first principal surface of the glass substrate 31, a flattening film 34 is further formed as an optical resin layer covering the thin film transistors 32 and the drive circuit 33, etc. , to flatten the surface. On the flattening film 34, pixel electrodes 35 are formed between wiring portions of the display area 21 to form the respective pixels G in the display area 21, while the spacers 18 are formed at positions other than the pixel electrodes 35 such as intersections of the wiring portions of the display area 21, and corrective structures 36, 36 serving as first protrusions are formed in a frame shape in the frame area 22. On the flattening film 34, an orientation film not shown is further formed in a manner covering the pixel electrodes 35.

The drive circuit 33 is connected electrically to the wiring portions. In addition, the drive circuit 33 may be formed on, for example, the glass substrate 31 or may be formed on, for example, a separate flexible substrate and the flexible substrate may in turn be connected electrically to the glass substrate 31.

The pixel electrodes 35 are each composed of a translucent conductive member such as ITO and formed in an approximately quadrilateral film shape. The pixel electrodes 35 are then connected electrically to the thin film transistors 32 via contact holes not shown formed in the flattening film 34.

The corrective structures 36, 36 are each composed of the same material as a member of, for example, synthetic resin forming each spacer 18 and formed in a quadrilateral frame shape at least in the vicinity of the corners of the frame area 22 and, in this embodiment, in a manner surrounding the entire display area 21. The structures have a shape protruding toward the front side of the counter substrate 16 and spaced from each other into an inner side relatively closer to the display area 21 and an outer side relatively farther from the display area 21. Accordingly, between the corrective structures 36, 36, an approximately U-shaped groove 39 to which a fluidic (liquid) sealing material 38 to form the sealed portion 19 is applied is formed with the first principal surface of the glass substrate 31. That is, the groove 39 is formed continuously in a quadrilateral frame and bank (ridge) shape all through the frame area 22. Also, the corrective structures 36, 36 are each formed in, for example, a trapezoidal shape in cross-section in which the width decreases toward the leading end, that is, the front side. Accordingly, the groove 39 is formed in a manner widened gradually toward the counter substrate 16.

The counter substrate 16 includes a (second) glass substrate 41 serving as a (second) substrate body and, on a first principal surface of the glass substrate 41 closer to the liquid crystal layer 17 and in the display area 21, a color filter layer 42 serving as a coloring layer, a black matrix layer 43 serving as a light-blocking layer, and a counter electrode 44 serving as a common electrode for setting a common potential are formed, while in the frame area 22, a counter structure 45 serving as a second protrusion is formed. On the first principal surface of the glass substrate 41, an orientation film not shown is further formed in a manner covering the counter electrode 44, etc.

In the color filter layer 42, coloring portions 42r, 42g, and 42b for R (red), G (green), and B (blue) are formed of, for example, synthetic resin sequentially in a stripe manner correspondingly to each pixel (sub-pixel) G. In addition, if the liquid crystal panel 11 is, for example, a monochrome display, not supporting color display, it is not necessary to provide the color filter layer 42. Alternatively, the color filter layer 42 may be formed on the array substrate 15.

The black matrix layer 43 is provided to prevent light leakage to the display side through an unnecessary portion and formed in a manner covering the portions of the array substrate 15 corresponding to the wiring portions and the portions corresponding to the frame area 22. In addition, the black matrix layer 43 may be formed on the array substrate 15 or the wiring, etc., on the array substrate 15 may have the feature of the black matrix layer 43.

The counter electrode 44 is composed of a translucent conductive member such as ITO and formed in a large quadrilateral shape in a manner opposed to at least all of the pixel electrodes 35 in the display area 21. The counter electrode 44 is then connected electrically to (for example, the wiring portions of) the array substrate 15 via transfer electrodes not shown formed to be provided between the array substrate 15 and the counter substrate 16.

The counter structure 45 is composed of the same material as a member of, for example, synthetic resin forming each spacer 18 and formed in a quadrilateral frame shape at least in the vicinity of the corners of the frame area 22, which corresponds to the positions of the corrective structures 36, 36, and, in this embodiment, at a position surrounding the entire display area 21. The structure has a shape protruding rearward, that is, toward the array substrate 15 and is inserted from the front side to be positioned in the groove 39 of the array substrate 15. That is, the counter structure 45 is formed continuously in a quadrilateral frame and bank (ridge) shape all through the frame area 22. Also, the counter structure is formed in, for example, a trapezoidal shape in cross-section in which the width decreases toward the leading end, that is, the rear side. The counter structure 45 is then spaced from the first principal surface of the glass substrate 31 of the array substrate 15 and positioned between the corrective structures 36, 36 being inserted in the groove 39.

The liquid crystal layer 17 may adopt one of various modes such as TN mode, STN mode, VA (MVA) mode, OCB mode, and IPS mode. In addition, if the liquid crystal layer 17 adopts, for example, IPS mode, the counter electrode 44 is provided on the array substrate 15.

The spacers 18 are, for example, columnar spacers, the leading ends thereof being in contact with the counter substrate 16 to maintain the gap between the substrates 15 and 16 at a predetermined value.

The sealed portion 19 is provided to encapsulate the liquid crystal layer 17 between the substrates 15 and 16 and formed through curing of the fluidic sealing material 38, for example, thermosetting resin or photo-curable resin such as ultraviolet (UV) curable resin. The sealed portion 19 is provided in an approximately U-shape between the corrective structures 36, 36 and the counter structure 45 and formed within the width between the leading ends of the corrective structures 36, 36. That is, the width of the sealed portion 19 is set by the corrective structures 36, 36.

Each polarizing plate is an optical member formed in a sheet (polarizing sheet) and disposed to selectively transmit or block a predetermined polarization component according to the mode of the liquid crystal layer 17.

The cover glass is a facing plate that protects the liquid crystal panel 11 so that the user cannot directly contact the liquid crystal panel 11, with various prints provided thereon, and is fixed adhesively to the liquid crystal panel 11 in a manner covering the front side of the liquid crystal panel 11. In addition, the cover glass may adopt a sensor-integrated cover glass in which a capacitance or resistive touch sensor, for example, is incorporated for the user to perform touch operations and inputs based on, for example, an image displayed in the display area 21 of the liquid crystal panel 11.

The backlight includes a light source such as a light emitting diode (LED), a quadrilateral light guide plate serving as a light guide body for converting light from the light source into planar light, a chassis frame supporting the light guide plate, a diffusion sheet and multiple prism sheets serving as optical sheets disposed in a laminated manner on the front side of the light guide plate, and a reflection sheet disposed in a laminated manner on the rear side of the light guide plate. The backlight is arranged to irradiate the rear side in at least the display area 21 of the liquid crystal panel 11 with planar light.

The chassis frame is composed of, for example, synthetic resin or metal and formed integrally in a quadrilateral frame shape, in which the liquid crystal panel 11, the backlight, etc., are housed in an anteroposteriorly stacked manner with the front side of the liquid crystal panel 11 being exposed.

Next will be described a method for manufacturing the liquid crystal panel 11 according to the first embodiment with reference also to FIG. 5.

The array substrate 15 is first manufactured by appropriately repeating, for example, a film forming step for film formation through sputtering or CVD, etc., on the glass substrate 31 and a patterning step for patterning through etching or photolithography, etc., to form the thin film transistors 32, the scan lines, the drive circuit 33, and the flattening film 34 (first forming step). Next, contact holes, etc., are formed in the flattening film 34, which is then covered with the pixel electrodes 35 formed through film formation and patterning (pixel electrode forming step). Further, the spacers 18 and the corrective structures 36, 36 are formed on the glass substrate 31 through a film formation and patterning (spacer (gap holding member) forming step and a corrective structure (first protrusion) forming step (FIG. 1(a))). At this time, the spacers 18 and the corrective structures 36, 36 may be composed of the same material to be formed simultaneously through the same film forming and patterning step. In addition, in each of the steps, the glass substrate 31 adopts an array-specific mother glass substrate 48, which, in general, is arranged integrally in a matrix.

The counter substrate 16 is manufactured by appropriately repeating, for example, a film forming step for film formation through sputtering or CVD, etc., on the glass substrate 41 and a patterning step for patterning through etching or photolithography, etc., to form the color filter layer 42 and the black matrix layer 43 (second forming step). Next, the counter electrode 44 is formed through film formation and patterning to cover the color filter layer 42 and the black matrix layer 43 (counter electrode forming step). Further, the counter structure 45 is formed on the glass substrate 41 through film formation and patterning (counter structure (second protrusion) forming step (FIG. 1(b))). In addition, the glass substrate 41 adopts a counter-specific mother glass substrate 49, which, in general, is arranged integrally in a matrix.

After the array substrate 15 and the counter substrate 16 are completed, the process advances to a cell step. In this cell step, the substrates 15 and 16 are respectively once rinsed (rinsing step), and then an orientation film is formed on each of the substrates 15 and 16 (orientation film forming step).

Next, for one of the substrates 15 and 16 on which the corrective structures 36, 36 are formed or, in this embodiment, for the array substrate 15, a predetermined applicator is used to apply the fluidic sealing material 38 into the groove 39 between the corrective structures 36, 36 (applying step (FIG. 1(c))) and to apply conductive paste, etc., to serve as the transfer electrodes (transfer applying step). At this time, the applicator uses a predetermined needle smaller than the width of the groove 39 to apply the sealing material 38 along the groove 39 in a loop manner.

After an appropriate amount of liquid crystal material is delivered by drops on the array substrate 15 inside the inner corrective structure 36, the array substrate 15 and the counter substrate 16 are aligned with each other and disposed in an opposed manner to be bonded to each other (disposing step (FIG. 1(d))). At this time, within the groove 39, the counter structure 45 of the counter substrate 16 presses and expands the sealing material 38 applied between the corrective structures 36, 36, so that the sealing material 38 runs over toward the counter substrate 16 along the clearance between the corrective structures 36, 36 and the counter structure 45 and is kept back at positions extending along the leading ends of the corrective structures 36, 36, resulting in that the sealing material 38 expands in an approximately U-shape to have a width equal to that between the leading ends of the corrective structures 36, 36. In this state, the leading end of the counter structure 45 is positioned within the groove 39 closer to the surface of the array substrate 15 (glass substrate 31) than the leading ends of the corrective structures 36, 36. The transfer electrodes composed of conductive paste provides electrical connections between the array substrate 15 and the counter substrate 16.

Thereafter, the sealing material 38 undergoes thermal or ultraviolet curing to form the sealed portion 19 that encapsulates the liquid crystal material (curing step (FIG. 1(e))), and the array substrate 15 and the counter substrate 16 are fixed to each other with the liquid crystal layer 17 provided therebetween.

Thereafter, during a predetermined post-process, the mother glass substrates 48 and 49 are divided into cells and a polarizing plate is applied to each of the cells to complete the liquid crystal panel 11.

The display device is then assembled by assembling and fixing the backlight, which is assembled separately from the liquid crystal panel 11, into the chassis frame and fixing the back side of the thus assembled liquid crystal panel 11 to the light guide plate (prism sheet) of the backlight.

When the thus assembled display device is connected to a power source, light from the light source is converted through the light guide plate into planar light, and the rear side of the liquid crystal panel 11 is irradiated with the planar light through the diffusion sheet and the prism sheets.

In the liquid crystal panel 11, the pixels G are driven by the thin film transistors 32 according to an image to be displayed and the direction of polarization of the incident planar light is converted through the polarizing plate on the back side, and thus the amount (of transmission) of light transmitting through the polarizing plate on the surface is set for each of the pixels G, whereby the light passing through the cover glass becomes visible to the user as an image.

As described heretofore, in accordance with the first embodiment, since the corrective structures 36, 36 and the counter structure 45 are each formed in a continuous bank shape, the sealing material 38 applied between the corrective structures 36, 36 can be pressed and expanded more reliably by the counter structure 45 and the expanded sealing material 38 can be kept back more reliably by the corrective structures 36, 36. It is therefore possible to set the width of the sealed portion 19, which is formed through curing of the sealing material 38, to a set value (distance between the leading ends of the corrective structures 36, 36) more reliably and thereby to reliably increase the bonding strength between the substrates 15 and 16 that the sealed portion 19 provides.

In addition, in the above-described first embodiment, at least either of the corrective structures 36, 36 or the counter structure 45 may be formed in a predetermined form in a plan view from the display side, as in a second embodiment shown in FIG. 6, such as a discontinuous (discrete) form in which quadrilateral dot patterns 36a and 45a as shown in FIGS. 6(a) and 6(b) or octagonal (circular) dot patterns 36b and 45b as shown in FIGS. 6(c) and 6(d) are separated from each other with a gap 50 therebetween having an area smaller, in a plan view from the display side, than that of the dot patterns 36a and 45a or the dot patterns 36b and 45b. In this case, the sealing material 38 pressed and expanded by the counter structure 45 within the groove 39 enters the gap 50 between the dot patterns 36a, 36a (dot patterns 36b, 36b) or the gap 50 between the dot patterns 45a, 45a (dot patterns 45b, 45b), resulting in a further increase in the bonding area, whereby it is possible to further increase the bonding strength between the substrates 15 and 16 that the sealed portion 19 provides, while achieving a narrowed frame.

Further, in the above-described embodiments, the corrective structures 36, 36 may be provided on the counter substrate 16, while the counter structure 45 may be provided on the array substrate 15. In this case, the sealing material 38 to form the sealed portion 19 is applied within the groove 39 between the corrective structures 36, 36 of the counter substrate 16. Similarly, the spacers 18 may be provided on the counter substrate 16. In this case, the shape of the pixel electrodes 35 is less likely to be limited by the spacers 18, and the liquid crystal panel 11 can have increased definition.

Furthermore, the liquid crystal layer 17 may be formed not only with a drop filling technique in which the substrates 15 and 16 (mother glass substrates 48 and 49) are bonded to each other with liquid crystal material preliminarily dropped, but also with, for example, a so-called vacuum filling technique in which after the substrates 15 and 16 (mother glass substrates 48 and 49) are bonded to each other at portions excluding a filling port, the filling port is dipped in the liquid crystal material in a vacuum and then subjected to atmospheric pressure so that the liquid crystal material is filled through and closes the filling port. In this case, although there occurs a pressure difference between the inside and the outside of the sealed portion 19 during the liquid crystal material filling step, the sealed portion 19 is held by the structures 36, 36, and 45 at a predetermined position and becomes less likely to be deformed inward by the pressure difference, whereby it is possible to ensure a positional accuracy of the sealed portion 19, being suitable for use in the liquid crystal panel 11 for mobile terminal applications, which particularly require high accuracy.

The structures 36, 36, and 45 may also be formed preferentially at positions where the amount of application of the sealing material 38 to form the sealed portion 19 is likely to decrease relative to other positions, for example, at the corners where the direction and rate of application by the applicator may change rapidly, and may not be formed at other positions.

Moreover, the liquid crystal panel 11 may not only be a transmissive or semi-transmissive type, but also be, for example, a so-called reflective type in which incident light is reflected to display an image.

Not only the liquid crystal panel 11 but also, for example, organic EL display devices and other types of display devices can also be supported as long as they have an arrangement in which substrates disposed in a mutually opposed manner are bonded to each other within a narrowed frame area.

In at least one of the above-described embodiments, the corrective structures 36, 36 protruding toward the counter substrate 16 are formed at least partially in the portions of the array substrate 15 corresponding to the frame area 22 and the fluidic sealing material 38 is applied between the corrective structures 36, 36, while the counter structure 45 protruding toward the array substrate 15 is formed in the portion of the counter substrate 16 corresponding to the frame area 22 and disposed between the corrective structures 36, 36 (within the groove 39) so that the counter structure 45 overlaps the corrective structures 36, 36, that is, the leading end of the counter structure 45 is positioned closer to the surface of the array substrate 15 than the leading ends of the corrective structures 36, 36 to press and expand the sealing material 38 between the corrective structures 36, 36. As a result, even if the frame area 22 may be narrowed, the sealing material 38 expands between the corrective structures 36, 36 as well as between the corrective structures 36, 36 and the counter structure 45, whereby the width of the sealed portion 19, which is formed through curing of the sealing material 38, can ensure a predetermined value (distance between the leading ends of the corrective structures 36, 36). In addition, the sealed portion 19 is bent in an approximately U-shape between the corrective structures 36, 36 and the counter structure 45, resulting in an increase in the bonding area compared to the case of flat bonding by the sealed portion 19. It is therefore possible to ensure a bonding strength between the substrates 15 and 16 that the sealed portion 19 provides, while achieving a narrowed frame.

In particular, by forming the corrective structures 36, 36 and the counter structure 45 at the corners of the frame area 22 where the direction and rate of application of the sealing material 38 by the applicator may change rapidly and the amount of application of the sealing material 38 is likely to decrease relative to other positions, the width and bonding area of the sealed portion 19 can be ensured by the corrective structures 36, 36 and the counter structure 45 even if the amount of application of the sealing material 38 may decrease, whereby the width can be approximately uniform all through the frame area 22. The bonding strength between the substrates 15 and 16 that the sealed portion 19 provides can therefore be stable.

Forming the corrective structures 36 of the same material as the spacers 18 for holding the gap between the substrates 15 and 16 allows the spacers 18 and the corrective structures 36 to be formed simultaneously in the same step. It is therefore possible to achieve material sharing and therefore component cost reduction as well as lead-time reduction, which can lead to a reduction in the manufacturing cost of the liquid crystal panel 11.

Further, since the counter structure 45 is sandwiched between the corrective structures 36, 36, the accuracy in the positioning (alignment) of the substrates 15 and 16 (mother glass substrates 48 and 49) can be improved.

Specifically, with a method similar to the process of forming a typical array substrate, film formation and patterning were repeated to form thin film transistors 32, an interlayer insulating film of 600 nm, signal lines, a flattening film 34, pixel electrodes 35, spacers 18, and corrective structures 36, 36 on a glass substrate 31. The corrective structures 36, 36 were spaced from each other at a width of design requirement added with approximately 50 μm on either end. Similarly, with a method similar to the process of forming a typical counter substrate, film formation and patterning were repeated to form a color filter layer 42, a black matrix layer 43, a counter electrode 44, and a counter structure 45 on a glass substrate 41. Thereafter, a liquid crystal panel 11 was formed with a method similar to the process of forming a typical liquid crystal panel. The thus created liquid crystal panel 11 was confirmed to have a sticking strength not different than conventionally and reliably not to suffer wiring corrosion, although having a frame area 22 narrower than conventionally in design. Also, by adopting this arrangement, the sealing line could be drawn stably to have a width as designed even if the amount of application of the sealing material 38 might be unstable at the corners of the frame area 22.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device having a display area for displaying an image therein and a frame area surrounding the display area, the display device comprising:
a pair of substrates disposed in a mutually opposed manner with a predetermined gap therebetween;
a pair of first protrusions disposed in at least a portion of the frame area in a mutually spaced manner and provided in a manner protruding from one toward the other of the substrates;
a second protrusion disposed in at least a portion of the frame area and provided in a manner protruding from the other substrate toward the one substrate, the leading end of the second protrusion coming closer to the surface of the one substrate than the leading ends of the first protrusions and positioned between the first protrusions; and
a sealed portion formed through curing of a fluidic sealing material applied between the first protrusions and provided between the first protrusions and the second protrusion to bond the pair of substrates to each other.

2. The display device according to claim 1, further comprising a gap holding member provided between the substrates to hold a gap between the substrates, wherein
at least either of the first protrusions or the second protrusion is formed of the same material as the gap holding member.

3. The display device according to claim 1, wherein the fluidic sealing material is thermosetting resin or photo-curable resin.

4. The display device according to claim 1, wherein
one of the pair of substrates is an array substrate and the other is a counter substrate, and wherein
a liquid crystal layer is provided between the substrates.

5. A method for manufacturing a display device including a pair of substrates disposed in a mutually opposed manner with a predetermined gap therebetween, the display device having a display area for displaying an image therein and a frame area surrounding the display area, the method comprising:
a first protrusion forming step of forming first protrusions protruding from one toward the other of the substrates in at least a portion of the frame area in a mutually spaced manner;
a second protrusion forming step of forming a second protrusion protruding from the other substrate toward the one substrate in at least a portion of the frame area;
an applying step of applying a fluidic sealing material between the first protrusions;
a disposing step of disposing the one substrate and the other substrate in an opposed manner so that the second protrusion is inserted between the first protrusions; and
a curing step of curing the sealing material to form a sealed portion to bond the pair of substrates to each other.

6. The method for manufacturing a display device according to claim 5, further comprising a gap holding member forming step of forming on at least one of the substrates a gap holding member arranged to hold a gap between the substrates, wherein
at least either of the first protrusion forming step or the second protrusion forming step is the same step as the gap holding member forming step, and at least either of the first protrusions or the second protrusion is formed of the same material as the gap holding member.

7. The method for manufacturing a display device according to claim 5, wherein thermosetting resin or photo-curable resin is used as the fluidic sealing material.

8. The method for manufacturing a display device according to claim 5, wherein
one of the pair of substrates is an array substrate and the other is a counter substrate, and wherein
a liquid crystal layer is provided between the substrates.
